(19) United States
(12) Patent Application Publication
(10) Pub. No.: US 2021/0287567 A1
(43) Pub. Date: Sep. 16, 2021

(54) SYSTEMS AND METHODS FOR INTERACTIVE ELECTRONIC LEARNING

(71) Applicant: Pearson Education, Inc., Bloomington, MN (US)

(72) Inventors: Ujjwal SINGH, Bangalore (IN); Martha J. REVENAUGH, Brooklyn, NY (US); Richa SINGH, Bangalore (IN); Manik KAKAR, Somerset, NJ (US); Nancy Elizabeth MOORE, Austin, TX (US)

(21) Appl. No.: 17/199,206

(22) Filed: Mar. 11, 2021

Related U.S. Application Data
(60) Provisional application No. 62/988,686, filed on Mar. 12, 2020.

(51) Int. Cl. G09B 19/02; H04L 12/24; G06F 3/0481; G06N 20/00; G09B 7/06; G09B 7/02

(52) U.S. Cl. CPC G09B 19/025; H04L 41/22; G09B 7/02; G06N 20/00; G09B 7/06; G06F 3/0481

(57) ABSTRACT

Covers various features of the Quikik product, specifically a feature for skill testing against an AI that determines pace through course content, and a feature for requesting answers from instructors, possibly utilizing answers to previously-answered questions or software solutions to math problems.

### CROSS-REFERENCE TO RELATED APPLICATION(S)

This application claims the benefit of priority from Provisional Application No. 62/988,686, filed under the same title on Mar. 12, 2020, the entire contents of which is incorporated herein by reference.

### FIELD OF THE INVENTION

This disclosure relates to the field of systems and methods configured to provide interactive electronic learning environments.

### SUMMARY OF THE INVENTION

The present invention relates to an electronic learning system and corresponding methods by which interactive content may be electronically delivered to a user (e.g., a student; a learner). In some embodiments, a curriculum for a subject (e.g., math, physics, etc.) or a branch (i.e., concept; category) may be presented to a student via an electronic device. The student may progress through the curriculum by completing assessments (e.g., quizzes, tests, and/or the like), and by viewing instructional learning materials (e.g., videos, textual explanations of concepts, example solutions to problems, and/or the like). For example, the system may guide the student to progress at an optimum personal speed through the curriculum, which may be optimized, at least in part, using a test-learn-apply learning progression framework that may utilize artificial-intelligence-derived information about a student user. For example, the test-learn-apply progression may involve testing a student to establish the student's baseline knowledge (“test”), teaching the student via a series of topic-based instructional learning materials (“learn”), and providing the student with opportunity to practice what they've learned via completion of assessments and/or practice questions (“apply”). Student activity may be monitored and corresponding activity data stored in a database of the system.

The curriculum may include gamified events, such as challenges in which a user competes against another user or an artificial intelligence (AI) entity to complete a timed assessment. In such challenges, the questions of the timed assessment may be presented to the user and their opponent (i.e., the AI entity or the other user) simultaneously or near-simultaneously. Each question of the challenge may have a limited time period for response, with both the user and their opponent being required to submit a response within the same limited time period. The user may be assigned points according to whether the user wins or loses a challenge, which may act as a mechanism for tracking the user's progress within the curriculum of a given subject or branch, or the overall general progress made by the user across all content of the electronic learning system.

In some embodiments, a help feature may be implemented as part of the electronic learning system to assist users with questions. A user may submit a question using the help feature. The electronic learning system may automatically generate or retrieve a solution to the question, or may send the question to a teacher or tutor to be manually solved. The user may view the solution via the user interface of their user device.

The above features and advantages of the present invention will be better understood from the following detailed description taken in conjunction with the accompanying drawings.

### BRIEF DESCRIPTION OF THE DRAWINGS

FIG. 1 illustrates a system level block diagram showing data stores, data centers, servers, and clients of a distributed computing environment, in accordance with an embodiment.

FIG. 2 illustrates a system level block diagram showing physical and logical components of a special-purpose computer device within a distributed computing environment, in accordance with an embodiment.

FIG. 3 shows an illustrative dashboard screen that may be displayed as part of a user interface of an electronic learning system, in accordance with an embodiment.

FIG. 4 shows an illustrative subject screen that may be displayed as part of a user interface of an electronic learning system, which includes a list of branches that are included in the subject, in accordance with an embodiment.

FIG. 5A shows an illustrative check tab of a branch screen that may be displayed as part of a user interface of an electronic learning system when a user's skill level has not yet been checked, in accordance with an embodiment.

FIG. 5B shows an illustrative check tab of a branch screen that may be displayed as part of a user interface of an electronic learning system when a user's skill level was previously checked, in accordance with an embodiment.

FIG. 6A shows an illustrative learning tab of a branch screen that may be displayed as part of a user interface of an electronic learning system when a user has completed at least a portion of the lessons available for the branch, in accordance with an embodiment.

FIG. 6B shows an illustrative learning tab of a branch screen that may be displayed as part of a user interface of an electronic learning system when a user has not yet started some of the lessons available for the branch, in accordance with an embodiment.

FIG. 7 shows an illustrative lesson screen that may be displayed as part of a user interface of an electronic learning system, which includes a selectively playable video lesson, in accordance with an embodiment.

FIG. 8 shows an illustrative practice tab of a branch screen that may be displayed as part of a user interface of an electronic learning system, in accordance with an embodiment.

FIG. 9 shows an illustrative question that may be displayed as part of an assessment given via a user interface of an electronic learning system following submission of a response by a user, in accordance with an embodiment.

FIG. 10 shows an illustrative question that may be displayed as part of an assessment given via a user interface of an electronic learning system prior to submission of a response by a user, in accordance with an embodiment.

FIG. 11 shows an illustrative challenge start screen that may be displayed as part of a user interface of an electronic learning system, which includes options for challenging either an artificial intelligence entity or another user, in accordance with an embodiment.

FIG. 12 shows an illustrative challenge question screen that may be displayed as part of a user interface of an electronic learning system during a challenge that has been initiated by a user, in which a question of the challenge is depicted along with the answer choices of the user and their opponent, in accordance with an embodiment.

FIG. 13A shows an illustrative challenge win screen that may be displayed as part of a user interface of an electronic learning system upon completion a challenge, which indicates whether the user won the challenge, in accordance with an embodiment.

FIG. 13B shows an illustrative challenge loss screen that may be displayed as part of a user interface of an electronic learning system upon completion a challenge, which indicates whether the user lost the challenge, in accordance with an embodiment.

FIG. 14 shows an illustrative process flow for a method by which a user may submit a question to an electronic learning system, and a solution to the question may be retrieved from a memory device and/or created either manually or automatically, in accordance with an embodiment.

FIG. 15 shows an illustrative portion of a dashboard screen that may be displayed as part of a user interface of an electronic learning system, which includes a help button, in accordance with an embodiment.

FIG. 16 shows an illustrative help screen that may be displayed as part of a user interface of an electronic learning system, which provides options to submit a question via text or via image upload, in accordance with an embodiment.

FIG. 17 shows an illustrative subject and branch selection screen that may be displayed as part of a user interface of an electronic learning system prior to submission of a question by a user, in accordance with an embodiment.

FIG. 18 shows an illustrative search results screen that may be displayed as part of a user interface of an electronic learning system in response to submission of a question by a user, in accordance with an embodiment.

FIG. 19A shows an example of a video solution screen that may be displayed as part of a user interface of an electronic learning system, in accordance with an embodiment.

FIG. 19B shows an example of a text solution screen that may be displayed as part of a user interface of an electronic learning system, in accordance with an embodiment.

FIG. 20 shows an example notification screen that may be displayed as part of a user interface of an electronic learning system, when the system determines that a solution corresponding to a submitted question does not exist in a solution database, in accordance with an embodiment.

FIG. 21 shows an example notification that may be sent to a user device by an electronic learning system when the electronic learning system determines that a solution to a previously submitted question is ready, in accordance with an embodiment.

FIG. 22 shows an illustrative teacher or tutor dashboard screen that may be displayed as part of a teacher user interface of an electronic learning system, in accordance with an embodiment.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Network

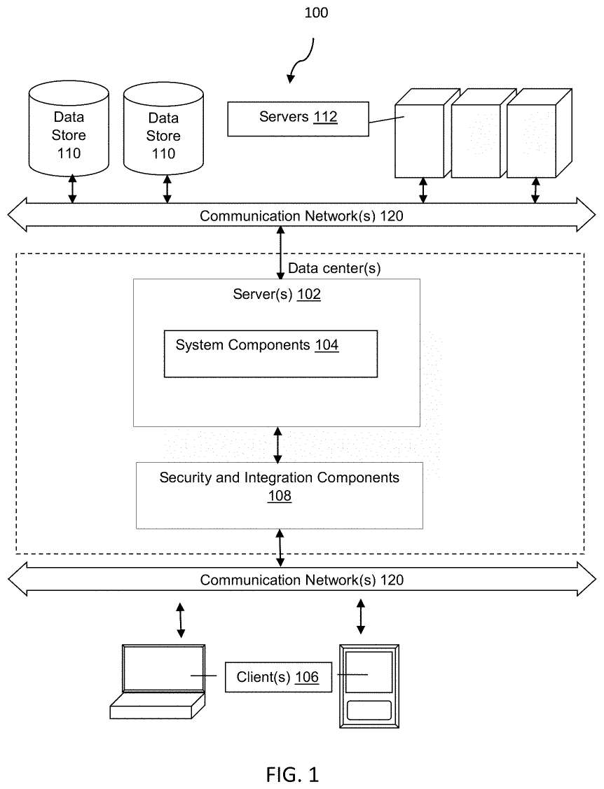

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

Servers/Clients

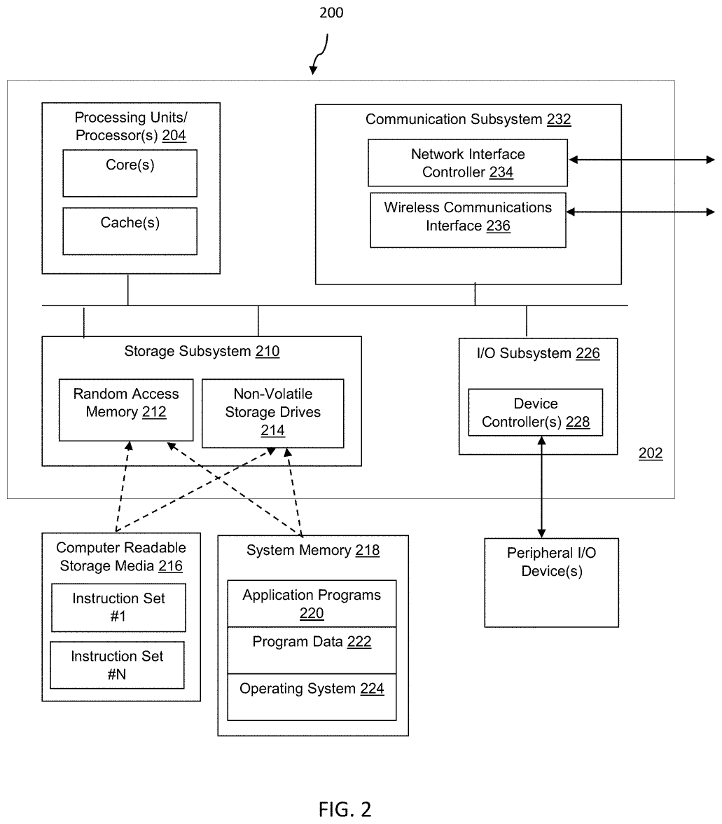

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

Security

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Data Stores (Databases)

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

Computer System

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

Processors

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Buses

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

Input/Output

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

Input

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

Output

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Memory or Storage Media

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Computer Readable Storage Media

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communication Interface

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

Input Output Streams Etc.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

Connect Components to System

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Other Variations

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

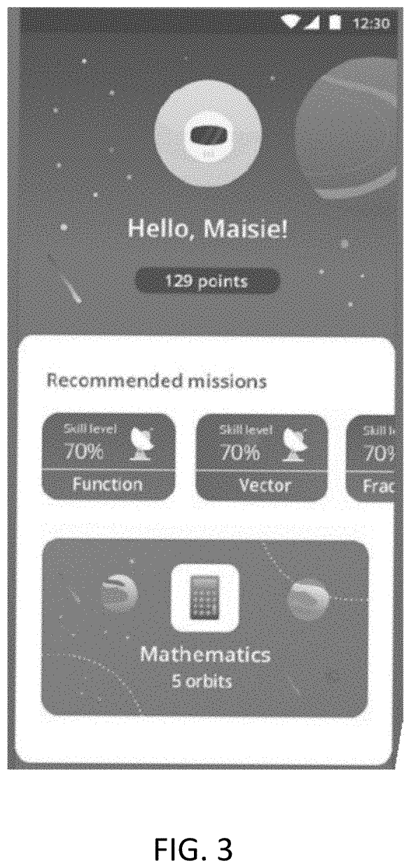

An electronic learning system may be implemented using the distributed computing environment and special purpose computer devices described above. For example, a user interface may be implemented and displayed at a user device of a user. Examples of screens that may be shown as part of the user interface of the electronic learning system are shown in FIGS. 3-13B. The content included in the user interface may be, at least in part, customized to be specific to a user account associated with the user. For example, the user interface may provide a number of subjects and corresponding branches (e.g., concepts or categories included a given subject). The user may progress through a curriculum for a given branch by completing assessments (e.g., quizzes, tests, activities, and/or the like) associated with that branch and/or by accessing (e.g., and watching, reading, etc.) lessons (e.g., video lessons, textual explanations of concepts, example solutions to problems, and/or the like) associated with that branch. User skill level may be determined based on a user's performance on assessments and/or the user's completion of lessons.

FIG. 3 shows an illustrative dashboard screen of the user interface, which may depict a user avatar, a user's name or username, a user's point total, subjects that are available to the user, recommendations (e.g., “missions”) for branches for the user of a subject for the user to learn and/or practice, and estimated skill levels of the user for each recommended branch.

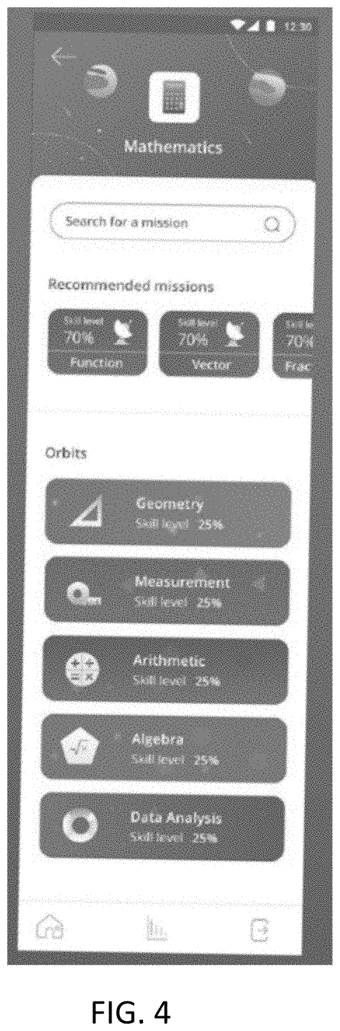

FIG. 4 shows an illustrative subject screen of the user interface, which may be accessed by selecting (e.g., clicking or touching) a subject from the dashboard screen. Recommendations for branches and corresponding estimated skill levels may still be displayed in a “recommended missions” section. The available branches (e.g., concepts, categories, or areas of study) within the subject are displayed under the orbits heading along with corresponding estimated skill levels of the user.

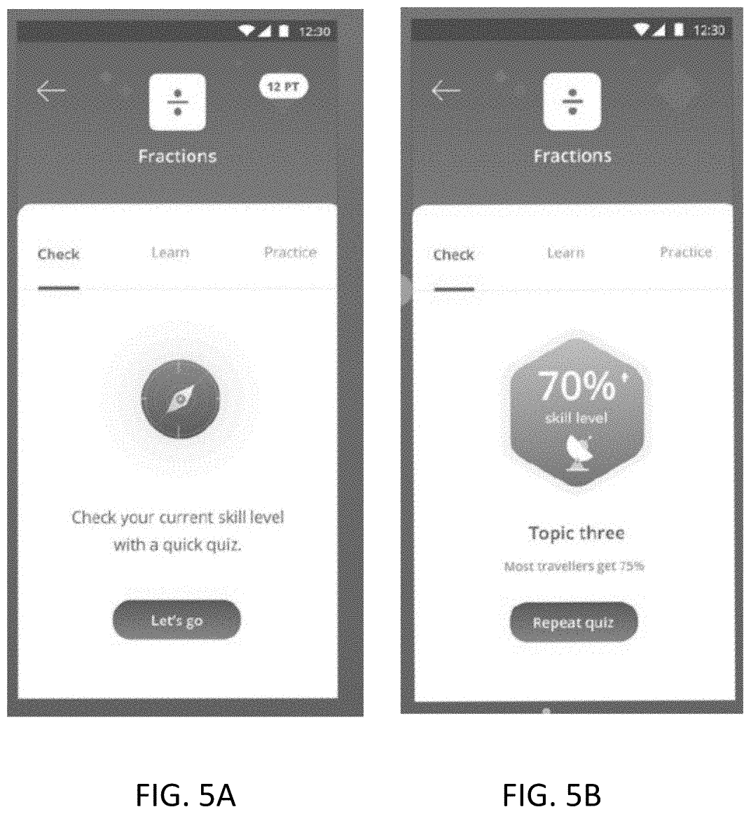

Upon selection of a branch, a multi-tabbed interface may be displayed, as shown in FIGS. 5A-6B and 8, which may include tabs for checking a user's skill level, learning topics associated with the selected branch, and practicing questions associated with the selected branch. For example, the content provided via the multi-tabbed user interface may provide a “test-learn-apply” learning progression framework, which may guide the user through the curriculum at an optimized pace.

FIGS. 5A and 5B show the multi-tabbed interface when a “check” tab is selected, which shows an estimated skill level of the user if the user has previously taken a skill level assessment quiz for the branch, or which otherwise prompts the user to check their skill level by selecting a corresponding button to take the skill level assessment quiz.

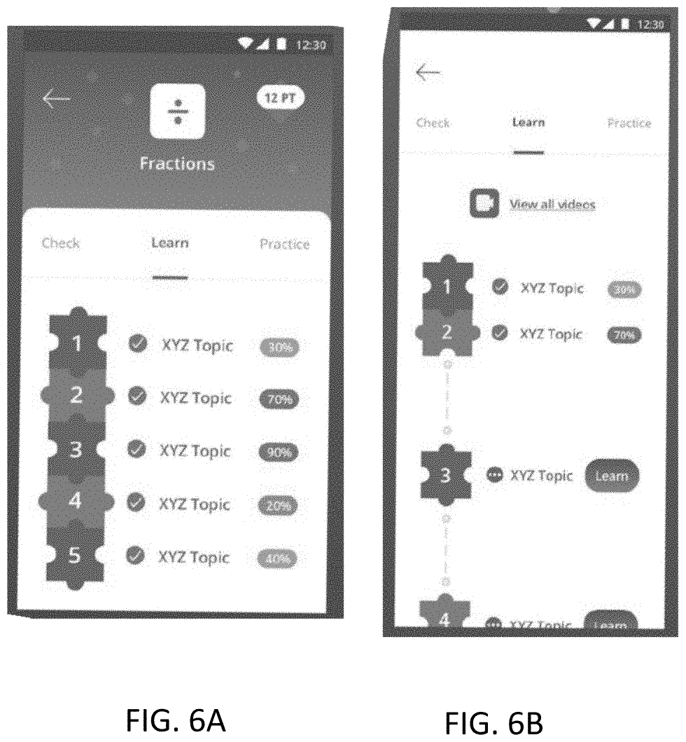

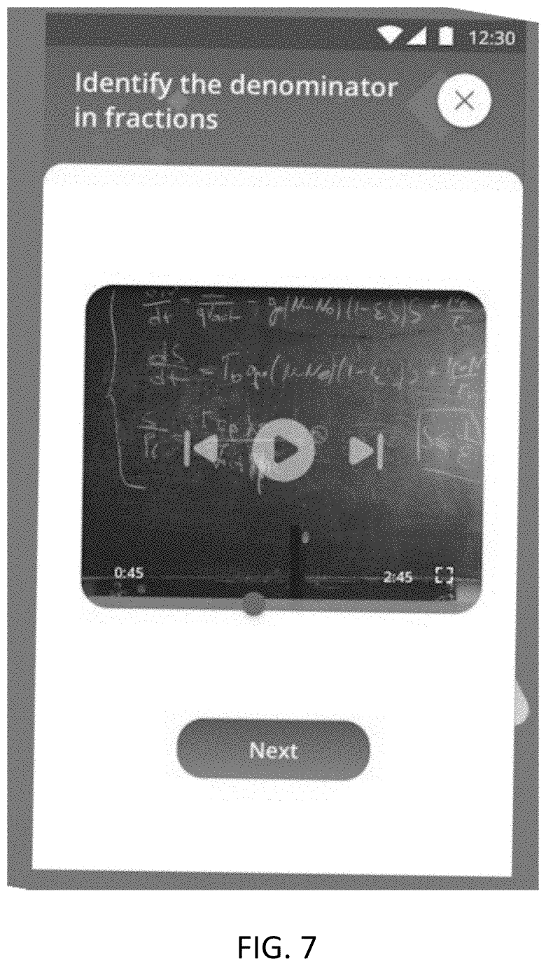

FIGS. 6A and 6B show the multi-tabbed interface when a “learn” tab is selected, which shows a listing of topics included in the branch. Each topic may be displayed alongside an indication of whether the user has previously accessed and/or partially or wholly completed content associated with that topic. Some topics may act as prerequisites as others, such that the electronic learning system may require the user to complete or partially complete one or more earlier topics in a prerequisite chain before the user can access a later topic in the prerequisite chain. Additionally, each topic that has been wholly or partially completed by a user may be displayed alongside an estimated skill level of the user with respect to that topic, which may be estimated based on previous user activity, such as previous user responses to assessment questions and/or previous access by the user of learning materials associated with that topic. Upon selecting a topic under the “learn” tab, the user interface may display one or more lessons or other learning materials to the user. For example, FIG. 7 shows an illustrative lesson screen that includes a video lesson on the topic of how to “identify the denominator in fractions”.

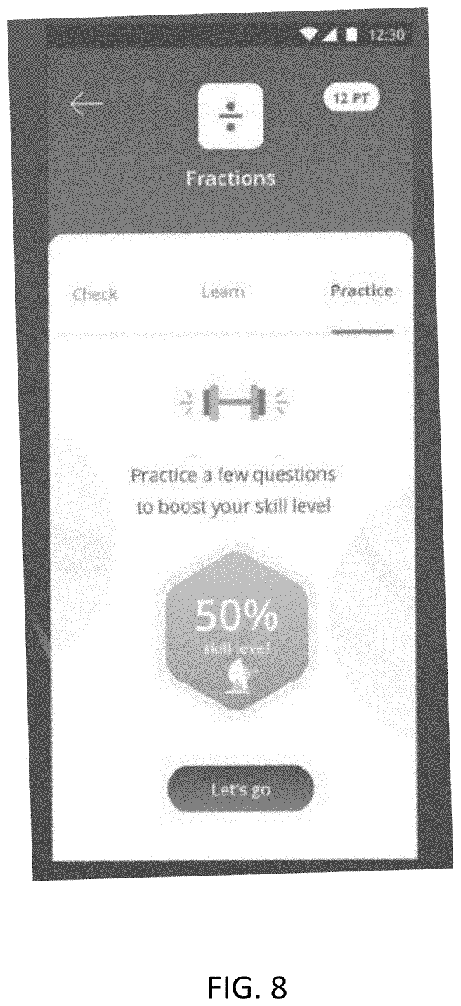

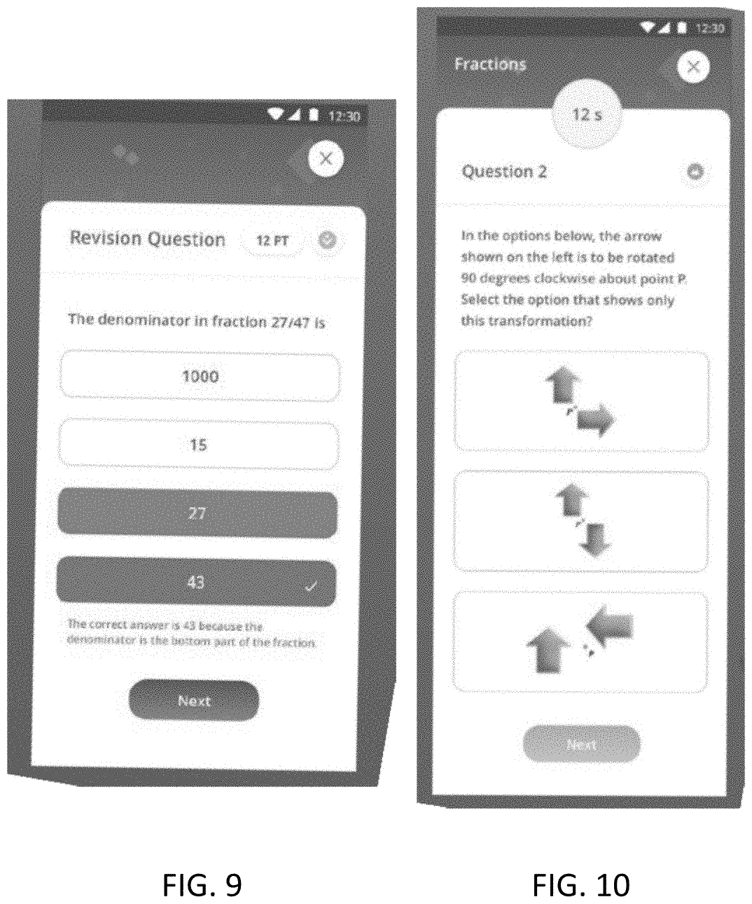

FIG. 8 shows the multi-tabbed interface when a “learn” tab is selected, which shows an estimated skill level of the user with respect to the branch along with a prompt for the user to practice questions to boost their skill level. Upon selecting an associated button, the user interface may display one or more practice questions related to the branch. For example, FIGS. 9 and 10 show examples of practice questions that may be provided via the user interface for the “fractions” branch. FIG. 9 shows the display of a question via the user interface following the submission of an incorrect response by the user. As shown, the incorrect answer choice corresponding to the user's response may be shown as highlighted in a first color (e.g., red), while the correct answer choice may be shown as highlighted in a second color (e.g., green). FIG. 10 shows the display of a question via the user interface prior to the submission of a response by the user. As shown, images may be provided as selectable responses in some instances, while text-based responses may be provided for selection in others.

It should be noted that questions provided via the user interface for skill level assessments, practice quizzes, and/or challenges may be retrieved (e.g., by a content delivery server of the electronic learning system) from one or more question data stores (e.g., which may be stored in one or more data store servers). For example, a respective question pool may be maintained in the question data stores for each branch.

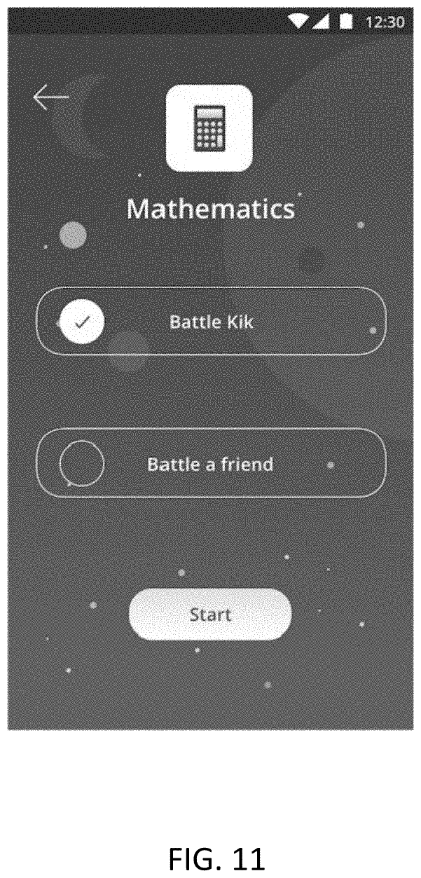

In addition to branch-specific assessments and lessons, the user interface of the electronic learning system may allow a user to participate in challenges in which the user may compete against another user or an artificial intelligence entity to complete a predetermined number of questions related to a selected branch. Examples of screens (i.e., “challenge screens”) that may be shown via the user interface when initiating and conducting a challenge are shown in FIGS. 11-13B. In such challenges, the questions of the timed assessment may be presented to the user and their opponent (i.e., the AI entity or the other user) simultaneously or near-simultaneously. Each question of the challenge may have a limited time period for response, with both the user and their opponent being required to submit a response within the same limited time period, else the non-responsive party will be considered by the system to have submitted an incorrect response. All participants may begin and end the challenge at the same time. The user and their opponent may accumulate points by answering questions correctly, with the amount of points gained for a given correct question being weighted based on the amount of time required to submit an answer to the question. In an embodiment, if an AI entity is challenged, the AI entity may pick answers randomly with a random amount of time delay. In an alternate embodiment, if an AI entity is challenged, the speed and accuracy with which the AI entity responds to challenge questions may be dynamically adjusted based on the proficiency (e.g., observed skill level) of the user that is challenging the AI entity. In some embodiments, multiple users may challenge the AI entity at the same time. When the last question of the challenge has been completed, the user or AI entity having the highest score may be determined the “winner” of the challenge. The electronic learning system may award progress points for the overall curriculum for all user participants, with more progress points being awarded to a user when the user wins a challenge than when the user loses the challenge.

FIG. 11 shows a challenge start screen that may be displayed via the user interface. The challenge start screen may include the subject to which the challenge corresponds, opponent selection buttons, and a start button. A user may select one of the opponent selection buttons to choose whether to challenge another user (“battle a friend”) or to challenge an artificial intelligence (AI) entity (“battle Kik”). If the user chooses to challenge another user, the user may be prompted to select the other user to battle before the challenge is able to start. If the user chooses to challenge Kik, the challenge may start upon the user's selection of the start button.

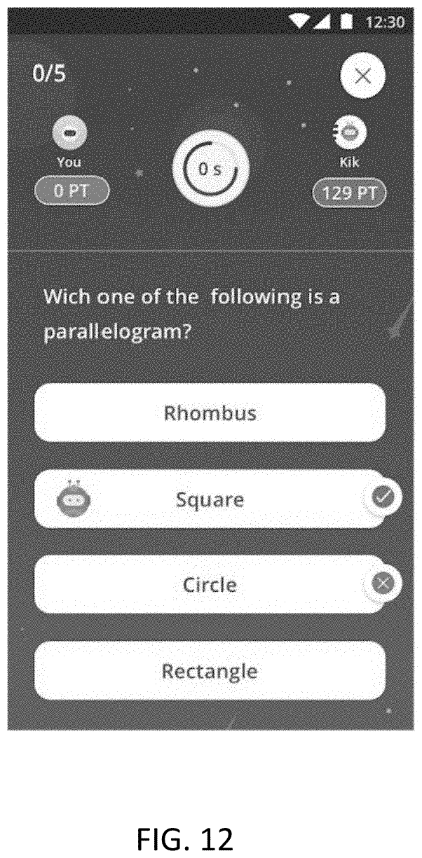

FIG. 12 shows a challenge question screen that may be displayed via the user interface. The challenge question screen may include a question, a number of selectable responses to the question, point totals for the user and their opponent, and a timer. In the present example, the user is challenging an AI entity, and the AI entity has selected the correct answer while the user has selected an incorrect answer. Once the user and their opponent have answered the question, an avatar of the opponent may be displayed at the opponent's answer choice, and indicators may be displayed alongside selected answer choices showing which was right and which were wrong. The timer may define a limited duration provided to the user and their opponent in which to respond to the question.

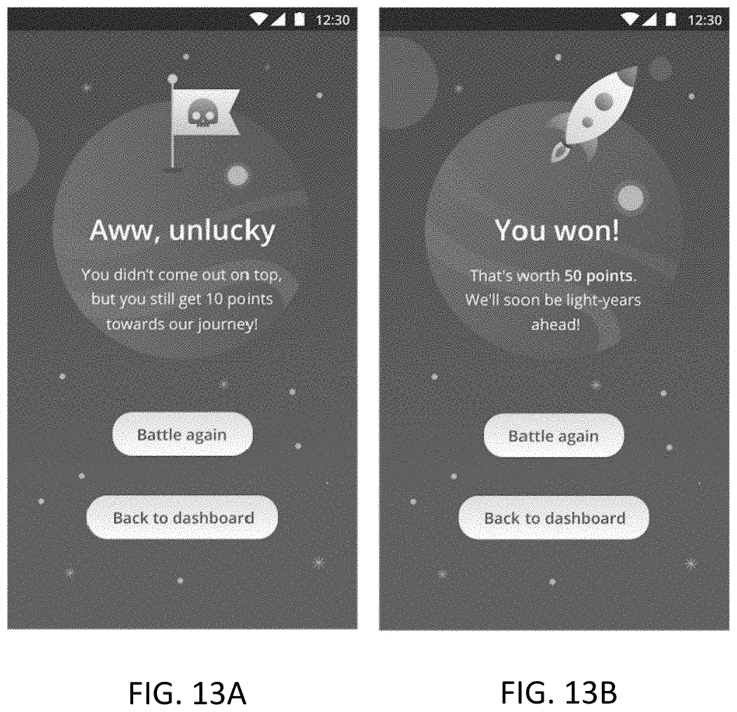

FIG. 13A shows a challenge loss screen that may be displayed via the user interface when a user loses a challenge. FIG. 13B shows a challenge win screen that may be displayed via the user interface when a user wins a challenge. Both the challenge win screen and the challenge loss screen may include an indicator of whether the user won or lost the challenge, may define a number of points won by the user, and/or navigation buttons which, upon selection, may cause the user interface to return to the challenge start screen or to the dashboard screen of the user interface.

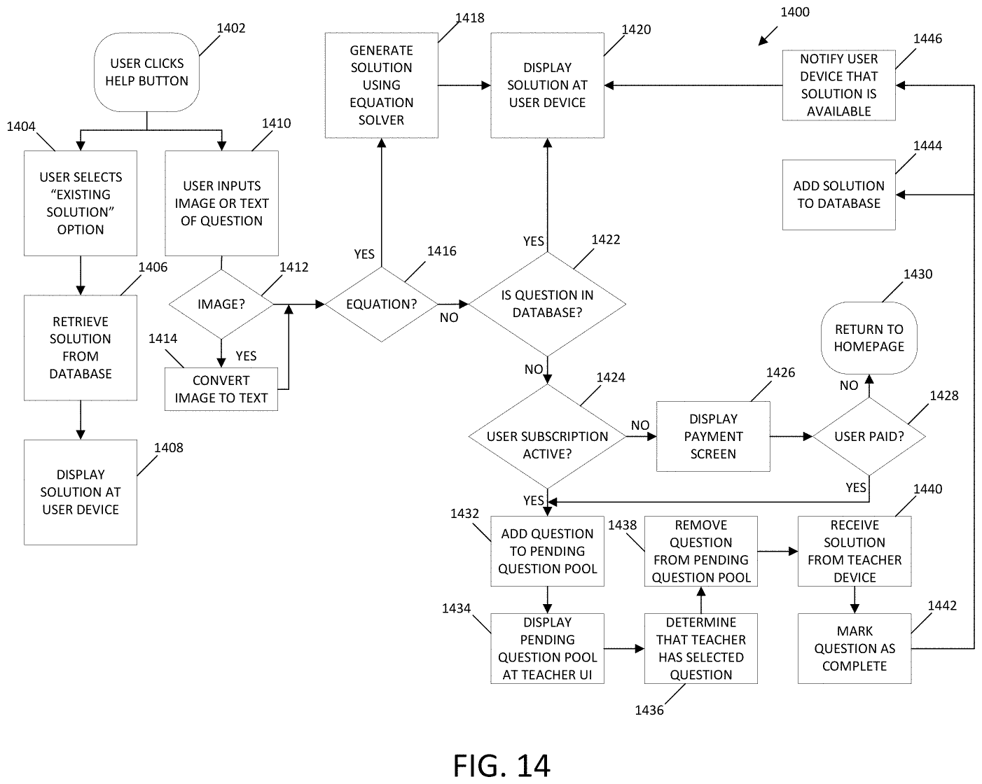

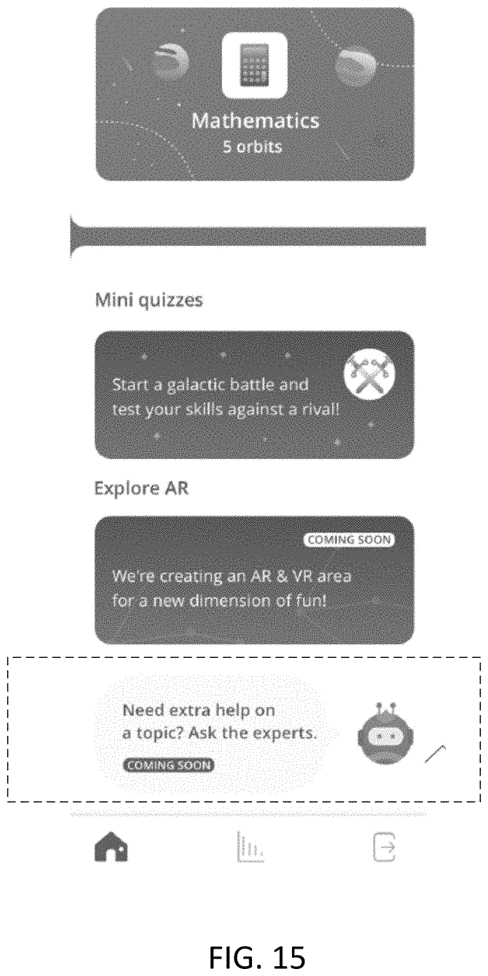

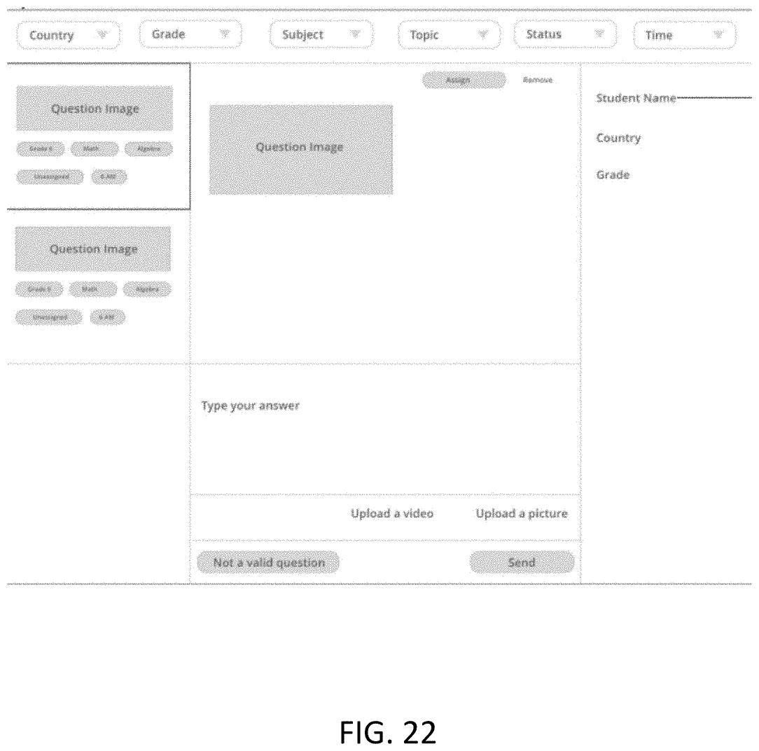

In some embodiments, a help system may be implemented as part of the electronic learning system to assist users with questions. An example of a method by which such a help system may be implemented is shown in FIG. 14, and screens of a user interface of the help system are shown in FIGS. 15-21. As shown, a user may submit a question (e.g., as a text submission or as a digital image) via interaction with a user interface of the help system, which may be displayed on the user's device. The submitted questions may be part of a curriculum delivered by the electronic learning system, although in some embodiments questions may be submitted that are outside of the curriculum. If the submitted question is an equation, an equation solver may be used to automatically generate a solution, which may then be displayed via the user interface. If the submitted question is not an equation, a question/answer database may be queried to determine whether the submitted question and a corresponding answer already exist in the question/answer database. If so, the answer corresponding to the submitted question may be retrieved from the question/answer database and may be presented to the user via the user interface. If not, the question may be added to a pending question pool. The pending question pool may be provided to teacher user interfaces (e.g., as shown in FIG. 22) of the electronic devices of teachers and/or tutors. A given teacher may select the submitted question from the pending question pool via the teacher user interface, and may upload a solution (e.g., which may be presented in the form of text, an image, audio, and/or video) to the electronic learning system, and may interact with the help system to mark the submitted question as complete. The submitted solution may be presented to the user via the user interface of the user's device. The submitted solution may also be added to the question/answer database. In some embodiments, the solution of a submitted question by a teacher or tutor may be a subscription-based service, such that the submitted question may only be added to the pending question pool if the user is actively subscribed to the service. If the user requests help by submitting a question that cannot be solved by an equation editor and does not have an active subscription, then the user may be taken to a payment screen and may be presented with an option to pay to activate the service. If the user chooses not to pay, the submitted question may not be added to the pending question pool. Otherwise, the process may proceed as described above for a user with an active subscription to the service, with a teacher or tutor ultimately providing a solution for the submitted question.

FIG. 14 shows an illustrative method 1400 by which a help system may be implemented as part of an electronic learning system.

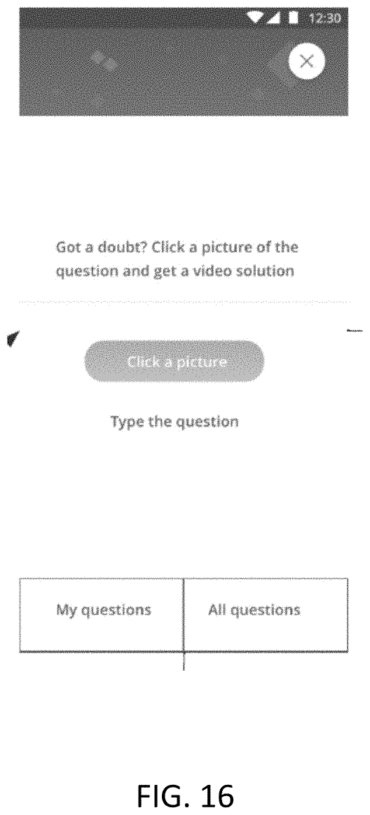

At step 1402, a help button of a user interface that is displayed on a user device is selected by a user. A corresponding server (e.g., servers 112, FIG. 1) may receive (e.g., via communication networks 120, FIG. 1) an indication that the help button has been selected. In response, the server causes a help screen (e.g., the help screen of FIG. 16) to be displayed via the user interface at the user device.

At step 1404, the user selects an “existing solution” option via interaction with the help screen, and the server receives a corresponding notification. For example, the selection of the “existing solution” option may be performed by the user upon accessing one or more lists of questions previously submitted by the user or by other users. The user may select one of the previously submitted questions in order to request access to the existing solution for that question.

At step 1406, the server retrieves the existing solution from a database, which may be stored in a memory device that is coupled to or included in the server. For example, the database may store previously submitted questions and corresponding solutions (e.g., which may have been previously provided by an equation solver or by a teacher, as will be described).

At step 1408, the server sends the existing solution that was retrieved from the database at step 1406 to the user device to be displayed to the user.

At step 1410, the user selects an option to input either text or a digital image corresponding to a question to which the user is requesting a solution to. The user then submits the text or image of the question via input/output devices (e.g., a software or hardware implemented keyboard or a camera) or via an image stored in memory of the user device. The server then receives the text or image from the user device.

At step 1412, the server determines whether the question was submitted as text or as a digital image. If the question was submitted as text (“submitted question text”), the method 1400 proceeds to step 1416. Otherwise, if the question was submitted as a digital image, the method proceeds to step 1414.

At step 1414, if the question is submitted in the form of an image, the server may perform image processing operations on the image in order to extract text (“extracted question text”) from the image.

At step 1416, the server determines whether the text of the submitted question corresponds to an equation. For example, the server may process the submitted question text or extracted question text (e.g., via execution of a natural language processing algorithm) in order to determine whether the question text corresponds to an equation (e.g., for which a solution could be determined using an equation solver). If the question text corresponds to an equation, the method 1400 proceeds to step 1418. Otherwise, if the question text does not correspond to an equation, the method 1400 proceeds to step 1422.

At step 1418, the server uses an equation solver to produce a solution for the equation of the submitted question. In some embodiments, the server itself executes the equation solver to produce the solution. In some alternate embodiments, the server may instead send the equation to be processed by an equation solver that is executed at a third-party server, and may receive the solution from the third party server. The server may then send the solution to be displayed at the user device at step 1420.

At step 1422, the server determines whether the question already exists in a solution database. The server may store the solution database on a local memory device of the server, or may communicate with a separate database server on which the solution database is stored in order to query the solution database. The solution database may store a record of questions that were previously submitted by users for which solutions were generated by a teacher or tutor (e.g., as opposed to being automatically generated by an equation solver). Each question may be associated with a corresponding solution, which may also be stored in the solution database. When the server queries the solution database with the text of a question, if the question or a substantially similar question exists in the database, the associated solution for that question is retrieved by the server and sent to the user device to be displayed at step 1420. However, if the submitted question or a substantially similar question is not included in the solution database, the method 1400 proceeds to step 1424.

At step 1424, the server determines whether a user account associated with the submitted question has an active subscription. For example, the on-demand creation of solutions to questions by teachers or tutors may be offered as a paid service (“solution service”). The solution service may require a subscription. In some embodiments, promotions may be implemented that result in students receiving free access to the solution service in a limited fashion (e.g., the user may be given a predetermined number of free days to use the solution service or a predetermined number of free solutions to be provided by the solution service). In such embodiments, the server may check (e.g., by querying one or more databases or look up tables stored at the server or a separate database server) to determine whether any such “free days” or “free solutions” are available to the user account in addition to checking to determine whether the user has a subscription. If the server determines, based on the user account, that the user has an active subscription or that the user has free days or free solutions available for the solution service, the method 1400 proceeds to step 1432. Otherwise, the method 1400 proceeds to step 1426.

At step 1426, the server causes a payment screen to be displayed at the user device. For example, the payment screen may prompt the user with an option to pay for a subscription to the solution service. In some embodiments, the payment screen may instead be a sequence of payment screens, which may vary in content depending on the method of payment used.

At step 1428, the server determines whether the user has paid for the solution service. If the user submitted payment for the solution service at step 1426, the method 1400 proceeds to step 1432. Otherwise, the method 1400 proceeds to step 1430, in which the server causes the user interface displayed at the user device to return to a homepage.

At step 1432, the server adds the submitted question to a pending question pool. The pending question pool may be a group of questions stored in a memory device of the server or a memory device that is in electronic communication with the server. The questions of the question pool may include non-equation questions that have been submitted by various users, and for which solutions have not yet been created by a teacher or tutor.

At step 1434, the server causes the pending question pool to be displayed at a teacher user interface. For example, a list of the questions of the pending question pool may be displayed as part of the teacher user interface at a teacher device associated with a teacher account. The teacher may choose a question to answer from among the questions of the pending question pool via the teacher user interface.

At step 1436, the server determines that the teacher has selected the submitted question (i.e., submitted at step 1410).

At step 1438, the server temporarily removes the submitted question from the pending question pool, such that the submitted question will not be displayed at other teacher devices. This may avoid a situation in which multiple teachers attempt to submit solutions to the same question. If the teacher submits a solution to the submitted question, then its removal from the pending question pool may be made permanent. However, the teacher may instead choose to return the question to the pending question pool, if desired.

At step 1440, the server receives a solution from the teacher device. The solution may be in text, digital image, or digital video format.

At step 1442, the server marks the submitted question as “complete”. For example, the server may modify a database entry associated with the submitted question to reflect that a solution has been provided for the submitted question. Upon being marked complete, the solution may be permanently removed from the pending question pool.

At step 1444, upon the submitted question being marked complete and/or the receipt of the solution from the teacher device, the solution is added to the solution database in association with the submitted question.

At step 1446, upon the submitted question being marked complete and/or the receipt of the solution from the teacher device, the server sends an electronic notification to the user device, indicating that a solution is available for the submitted question. The server may then display the solution at the user device at step 1420 (e.g., in response to the user interacting with the user interface at the user device to cause the solution to be displayed).

FIG. 15 shows a portion of a dashboard screen that may be displayed via the user interface, which includes a help button. Upon selection of the help button, the user interface may display a help screen.

For example, FIG. 16 shows a help screen that may be displayed via the user interface. The help screen may provide selectable options to take a picture (e.g., allowing a user to submit a question as a digital image when selected), type a question (e.g., allowing a user to submit a question as text when selected), view “my questions” (e.g., navigating to a screen that lists questions that were previously submitted by the user when selected), and view “all questions” (e.g., navigating to a screen that lists all questions that have been submitted via the help system when selected).

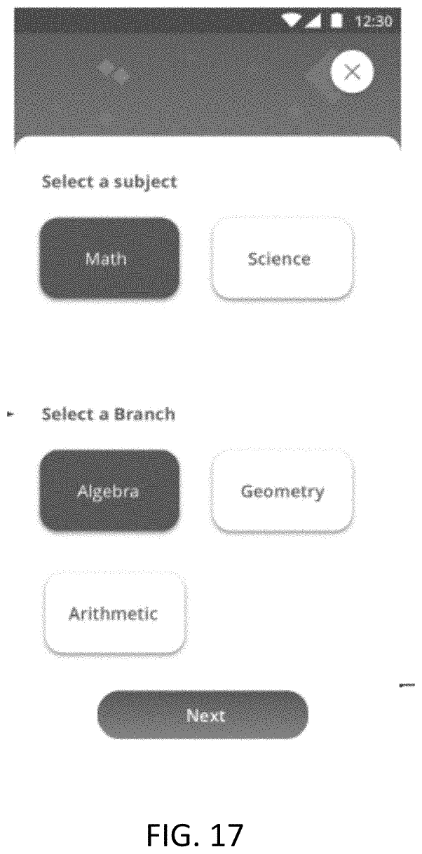

FIG. 17 shows a subject and branch selection screen, which may be displayed upon selection of the “take a picture” or “type a question” options of the help screen. At the subject and branch selection screen, a user may select a subject that corresponds to the question they intend to submit, and may then select a branch included in the selected subject that corresponds to the question they intend to submit.

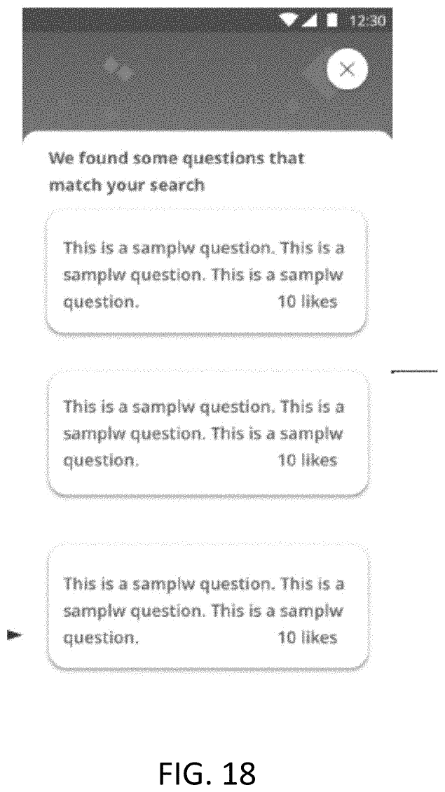

FIG. 18 shows a search results screen that shows other questions that are related to a question submitted by a user. For example, the electronic learning system may query a question database to identify any previously submitted questions that match or substantially match the question presently being submitted. If matching or substantially matching questions are identified, they may be included in the search results screen. However, if a matching or substantially matching question does not exist in the question database, the search results screen may not be displayed, and a new solution may be generated automatically or manually. A user may also select to skip the search results screen, for example, if the user determines that none of the displayed questions are sufficiently relevant to the question submitted by the user.

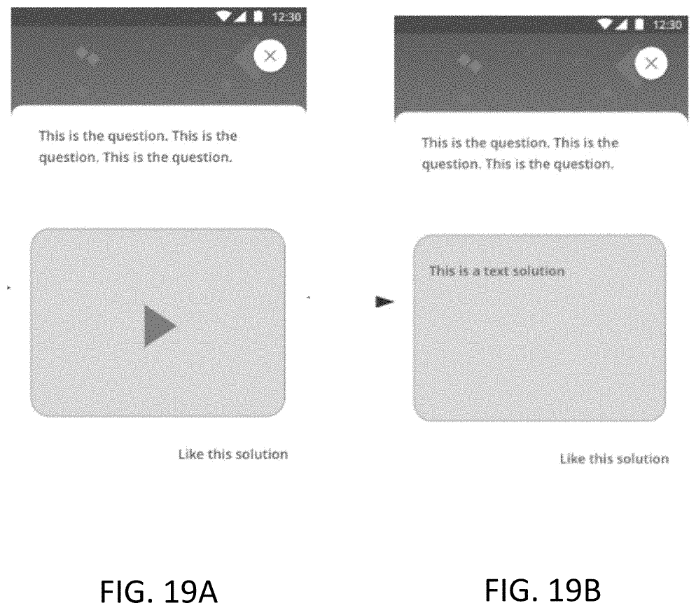

FIGS. 19A and 19B show example solution screens that may be displayed via the user interface in response to a question being submitted by a user. For example, FIG. 19A shows the submitted question and a video solution which may have been automatically generated and/or “manually” generated by a teacher or tutor. For example, FIG. 19B shows the submitted question and a text solution which may have been automatically generated and/or “manually” generated by a teacher or tutor. Here, manual generation of a solution refers to generation of the solution by a person, rather than by a computer only.

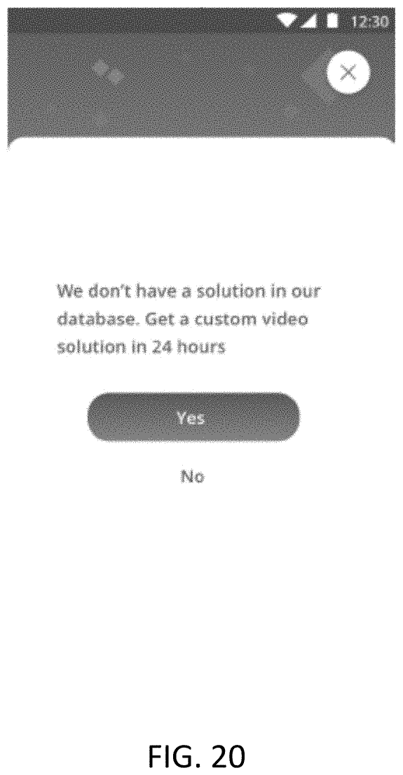

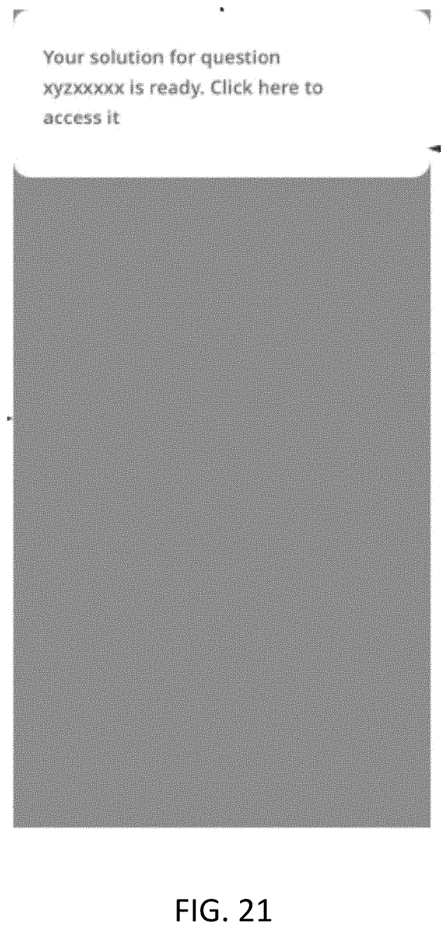

FIG. 20 shows an example notification screen that may be displayed upon the determination by the electronic learning system that no question of the question database sufficiently matches the question submitted by the user, and that an equation editor is not applicable for solving the question (e.g., if the question is not a math problem). As shown, the notification screen may prompt the user to receive a custom video solution within a predetermined time period (e.g., 24 hours). The user may select whether to request the custom solution by pressing the “yes” or “no” buttons included in the notification screen. If the user selects “yes”, then the submitted question may be added to a question pool, where it may be available for selection by a teacher or tutor. FIG. 21 shows a notification (e.g., which may be a text notification or a push notification) that may be displayed when such a custom solution is available. For example, the electronic learning system may send the notification to the user device of the user in response to the submission of the solution to the electronic learning system by the teacher via the teacher user interface.

FIG. 22 shows a teacher user interface from which a teacher may obtain a question to answer from a pool of unanswered questions. The teacher may organize the question pool according to the country or grade of the user that submitted the question, the subject or topic of the question, the status of the question, and/or the time at which the question was submitted. The teacher user interface may include an “upload a video” button and an “upload a picture” button. Upon selecting the “upload a video” button, the teacher may be prompted to select and upload a video as a solution to a question that the teacher has selected. Upon selecting the “upload a picture” button, the teacher may be prompted to select and upload a picture as a solution to a question that the teacher has selected. When a teacher obtains a question from the question pool, the question may be removed from the question pool, such that the obtained question will no longer be available to other teachers. The teacher may later release the question back into the question pool (e.g., by selecting a previously obtained question and then selecting the “remove” button) rather than submitting a solution to the question, if desired.

The teacher user interface may further include a “not a valid question” button, which, when selected in conjunction with the selection of a question from the question pool, may cause the question to be removed from the question pool and indicated to be invalid. For example, the user that submitted the question may be sent a notification by the electronic learning system indicating that the question has been marked as invalid.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method comprising:
storing, within a database coupled to a network of computing devices:
a plurality of challenge questions, each associated with a learning topic within a curriculum; and
a plurality of user profiles comprising a user activity data for each of a plurality of users;
receiving, by a server comprising at least one computing device coupled to the network and comprising at least one processor executing instructions within a memory, from a first graphical user interface (GUI) displayed on a client device coupled to the network and operated by a user, a first user input selecting an artificial intelligence (AI) software module running on the server as an opponent in a learning challenge;
executing, by the server, a first database command selecting, for the learning challenge, a challenge question in the plurality of challenge questions;
generating, by the server, for transmission to and display on the client device, a second GUI comprising the challenge question and a plurality of selectable responses;
receiving, by the server:
at a first time, a second user input comprising a first response selected from the plurality of selectable responses; and
at a second time, a second response generated by the AI software module;
calculating, by the server a first score for the first response and a second score for the second response, according to a determination of whether the first response and the second response are correct;
generating, by the server, for transmission to and display on the client device, a third GUI comprising the determination of whether the first response is correct and the first score;
calculating, by the server, utilizing the AI software module and the user activity data, a personalized progression of the user through the topic or the curriculum;
receiving, by the server from the client device, a question from the user; and
generating, by the server for transmission to and display on the client device, a fourth GUI comprising an answer to the question.

2. The method of claim 1, further comprising the steps of:
storing, by the server, the curriculum, and the learning topic within at least one topic in the curriculum, within the database, according to a test-learn-apply learning progression;
generating, by the server, within the first GUI:
a menu for selecting the topic from the at least one topic in the curriculum;
a check tab for accessing a test portion of the test-learn-apply learning progression;
a learn tab for accessing a learn portion of the test-learn-apply learning progression;
a practice tab for accessing an apply portion of the test-learn-apply learning progression.

3. The method of claim 2, further comprising the steps of:
storing, by the server in the database, a plurality of user input from the check tab, the learn tab, and the practice tab as the user activity data;
identify the personalized progression through the topic or the curriculum according to the user activity data generated from the plurality of user input from the check tab, the learn tab, and the practice tab.

4. The method of claim 1, further comprising the steps of displaying, by the server on the first GUI, a selectable GUI component for selecting a second user as an opponent.

5. The method of claim 1, further comprising the step of generating, by the server within the third GUI:
a first indication of whether the first response is correct or incorrect;
a second indication of whether the second response is correct or incorrect; and
the first score and the second score.

6. The method of claim 1, further comprising the steps of:
storing, by the server, in the database:
a plurality of questions; and
a plurality of answers each associated with one of the plurality of questions;
receiving, by the server from the client device, a request to submit the question;
generating, by the server, for transmission to and display on the client device, a fifth GUI for receiving the question from the user;
receiving, by the serer from the client device via the fifth GUI, the question;
responsive to a determination that the plurality of questions include a corresponding question to the question, execute a database command selecting the answer in the plurality of answers associated, in the database, with the corresponding question;
responsive to a determination that the plurality of questions do not include the corresponding question:
add the question to a question pool comprising a plurality of received questions; and
receive the answer to the question; and
generate, for transmission to and display on the client device, a sixth GUI comprising the answer to the question.

7. The method of claim 6, further comprising the steps of:
identifying, by the server, the question received from the user as an image input or a text input;
responsive to a determination that the question received from the user is an image input, converting, by the server, the image into a text input.

8. The method of claim 7, further comprising the steps of:
Identifying, by the server, the question as a mathematical equation;
executing, by the server, an equation solver software module, running on the server, configured to generate a solution to the mathematical equation;
generating, by the server for transmission through the network and display on the sixth GUI, the solution to the mathematical equation.

9. The method of claim 8, further comprising the steps of:
generating, by the server, an instructor GUI, for transmission through and display on a second client device operated by an instructor, the instructor GUI comprising the question pool;
receiving, by the server via the instructor GUI:
a third user input from the instructor selecting the question from the question pool; and
a fourth user input from the instructor comprising the answer to the question;
storing, by the server, the answer in the database; and
displaying, by the server on the second GUI:
a notification that the answer to the question is available; and
the answer to the question.

10. The method of claim 9, further comprising the step of, responsive to the second user input from the instructor selecting the question from the question pool, removing, by the server, the question from the question pool and from the instructor GUI.

11. A system comprising:
a database coupled to a network of computing devices and storing:
a plurality of challenge questions, each associated with a learning topic within a curriculum; and
a plurality of user profiles comprising a user activity data for each of a plurality of users;
a client device coupled to the network and operated by a user in the plurality of users; and
a server comprising at least one computing device coupled to the network and comprising at least one processor executing instructions within a memory which, when executed, cause the system to:
receive, from a first graphical user interface (GUI) displayed on the client device, a first user input selecting an artificial intelligence (AI) software module running on the server as an opponent in a learning challenge;
execute a first database command selecting, for the learning challenge, a challenge question in the plurality of challenge questions;
generate, for transmission to and display on the client device, a second GUI comprising the challenge question and a plurality of selectable responses;
receive:
at a first time, a second user input comprising a first response selected from the plurality of selectable responses; and
at a second time, a second response generated by the AI software module;
calculate a first score for the first response and a second score for the second response, according to a determination of whether the first response and the second response are correct; and
generate, for transmission to and display on the client device, a third GUI comprising the determination of whether the first response is correct and the first score; and
calculate, utilizing the AI software module and the user activity data, a personalized progression of the user through the topic or the curriculum.

12. The system of claim 11, wherein the instructions, when executed, further cause the system to:
store the curriculum, and the learning topic within at least one topic in the curriculum, within the database, according to a test-learn-apply learning progression;
generate, within the first GUI:
a menu for selecting the topic from the at least one topic in the curriculum;
a check tab for accessing a test portion of the test-learn-apply learning progression;
a learn tab for accessing a learn portion of the test-learn-apply learning progression;
a practice tab for accessing an apply portion of the test-learn-apply learning progression.

13. The system of claim 12, wherein the instructions, when executed, further cause the system to
store, in the database, a plurality of user input from the check tab, the learn tab, and the practice tab as the user activity data;
identify the personalized progression through the topic or the curriculum according to the user activity data generated from the plurality of user input from the check tab, the learn tab, and the practice tab.

14. The system of claim 11, wherein the instructions, when executed, further cause the system to display, on the first GUI, a selectable GUI component for selecting a second user as an opponent.

15. The system of claim 11, wherein the instructions, when executed, further cause the system to generate, within the third GUI:
a first indication of whether the first response is correct or incorrect;
a second indication of whether the second response is correct or incorrect; and
the first score and the second score.

16. A system comprising:
a database coupled to a network of computing devices and storing:
a plurality of questions; and
a plurality of answers each associated with one of the plurality of questions;
a client device coupled to the network and operated by a user; and
a server comprising at least one computing device coupled to the network and comprising at least one processor executing instructions within a memory which, when executed, cause the system to:
receive, from the client device, a request to submit a question;
generate, for transmission to and display on the client device, a graphical user interface (GUI) for receiving the question from the user;
receive, from the client device via the GUI, a first user input from the user comprising the question;
responsive to a determination that the plurality of questions include a corresponding question to the question, execute a database command selecting an answer in the plurality of answers associated, in the database, with the corresponding question;
responsive to a determination that the plurality of questions do not include the corresponding question:
add the question to a question pool comprising a plurality of received questions; and
receive the answer to the question; and
generate, for transmission to and display on the client device, a second GUI comprising the answer to the question.

17. The system of claim 16, wherein the instructions, when executed, further cause the system to:
identify the question received from the user as an image input or a text input;
responsive to a determination that the question received from the user is an image input, convert the image into a text input.

18. The system of claim 17, wherein the instructions, when executed, further cause the system to:
identify the question as a mathematical equation;
execute an equation solver software module, running on the server, configured to generate a solution to the mathematical equation;
generate, for transmission through the network and display on the second GUI, the solution to the mathematical equation.

19. The system of claim 18, wherein the instructions, when executed, further cause the system to:
generate an instructor GUI, for transmission through and display on a second client device operated by an instructor, the instructor GUI comprising the question pool;
receive, via the instructor GUI:
a second user input from the instructor selecting the question from the question pool; and
a third user input from the instructor comprising the answer to the question;
store the answer in the database; and
display, on the second GUI:
a notification that the answer to the question is available; and
the answer to the question.

20. The system of claim 19, wherein the instructions, when executed, further cause the system to, responsive to the second user input from the instructor selecting the question from the question pool, remove the question from the question pool and from the instructor GUI.
